(19) United States
(12) Patent Application Publication
(10) Pub. No.: US 2011/0184879 A1
(43) Pub. Date: Jul. 28, 2011

(54) METHOD AND APPARATUS FOR SOCIALLY ACQUIRING GOODS OR SERVICES

(75) Inventors: Risto YLIVAINIO, Vancouver (CA); Toni Kopra, Espoo (FI)

(73) Assignee: Nokia Corporation, Espoo (FI)

(21) Appl. No.: 12/695,603

(22) Filed: Jan. 28, 2010

(51) Int. Cl. G06F 15/16; G06Q 99/00; G06Q 50/00; H04L 1/08; G06F 11/14

(52) U.S. Cl. 705/319; 709/217; 714/748; 709/227; 714/E11.113

(57) ABSTRACT

An approach is provided for coordinating the acquisition of items. Acquisition information for a plurality of items is received. Transmission of the acquisition information is caused, at least in part, to a plurality of devices. Status information related to acquiring at least a portion of the items is received from at least one of the devices. Transmission of the status information to at least another one of the devices is caused, at least in part.

### BACKGROUND

Popular methods of distributing goods and/or services to users include causing users to wait on line or on the phone to order goods and/or services (e.g., obtaining event tickets) as well as providing ordering via other methods (e.g., via the internet). Generally, the providers of the goods and/or services attempt to create a “buzz” for the goods and/or services by setting an availability time for the goods and/or services. As such, the people interested in acquiring the goods and/or services may attempt to acquire the goods and/or services at the same time and/or may have to wait for an extended amount of time to receive the goods and/or services. Moreover, the providers may wish to encourage users to attempt to acquire the goods and/or services at or around the availability time by limiting the availability and/or quantity of the goods and/or services. Thus, the users may be required to attempt to acquire the goods and/or services from the providers without having a 100% chance to acquire the goods and/or services the users wish to acquire.

### SOME EXAMPLE EMBODIMENTS

Therefore, there is a need for an approach for coordinating the acquisition of goods and/or services among multiple users.

According to one embodiment, a method comprises receiving acquisition information for a plurality of items. The method also comprises causing, at least in part, transmission of the acquisition information to a plurality of devices. The method further comprises receiving from at least one of the devices status information related to acquiring at least a portion of the items. The method additionally comprises causing, at least in part, transmission of the status information to at least another one of the devices.

According to another embodiment, an apparatus comprising at least one processor, and at least one memory including computer program code, the at least one memory and the computer program code configured to, with the at least one processor, cause, at least in part, the apparatus to receive acquisition information for a plurality of items. The apparatus additionally causes, at least in part, transmission of the acquisition information to a plurality of devices. The apparatus is further caused to receive from at least one of the devices status information related to acquiring at least a portion of the items. The apparatus additionally causes, at least in part, transmission of the status information to at least another one of the devices.

According to another embodiment, a computer-readable storage medium carrying one or more sequences of one or more instructions which, when executed by one or more processors, cause, at least in part, an apparatus to receive acquisition information for a plurality of items. The apparatus additionally causes, at least in part, transmission of the acquisition information to a plurality of devices. The apparatus is further caused to receive from at least one of the devices status information related to acquiring at least a portion of the items. The apparatus additionally causes, at least in part, transmission of the status information to at least another one of the devices.

According to another embodiment, an apparatus comprises means for receiving acquisition information for a plurality of items. The apparatus also comprises means for causing, at least in part, transmission of the acquisition information to a plurality of devices. The apparatus further comprises means for receiving from at least one of the devices status information related to acquiring at least a portion of the items. The apparatus additionally comprises means for causing, at least in part, transmission of the status information to at least another one of the devices.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of coordinating the acquisition of items, according to one embodiment;

FIG. 2 is a diagram of the components of a social networking platform capable of coordinating the acquisition of items, according to one embodiment;

FIG. 3 is a diagram of the components of user equipment, according to one embodiment;

FIG. 4A is a flowchart of a process for coordinating the acquisition of items, according to one embodiment;

FIG. 4B is a diagram of a user interface utilized during the process of acquiring items, according to one embodiment;

FIG. 5 is a flowchart of a process for alerting users of an item acquisition event, according to one embodiment;

FIG. 6 is a flowchart of a process for coordinating the acquisition of items, according to one embodiment;

FIG. 7 is a flowchart of a process for presenting item acquisition status information, according to one embodiment;

FIGS. 8A-8D are diagrams of user interfaces utilized in the processes of FIGS. 4-7, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for coordinating the acquisition of items are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

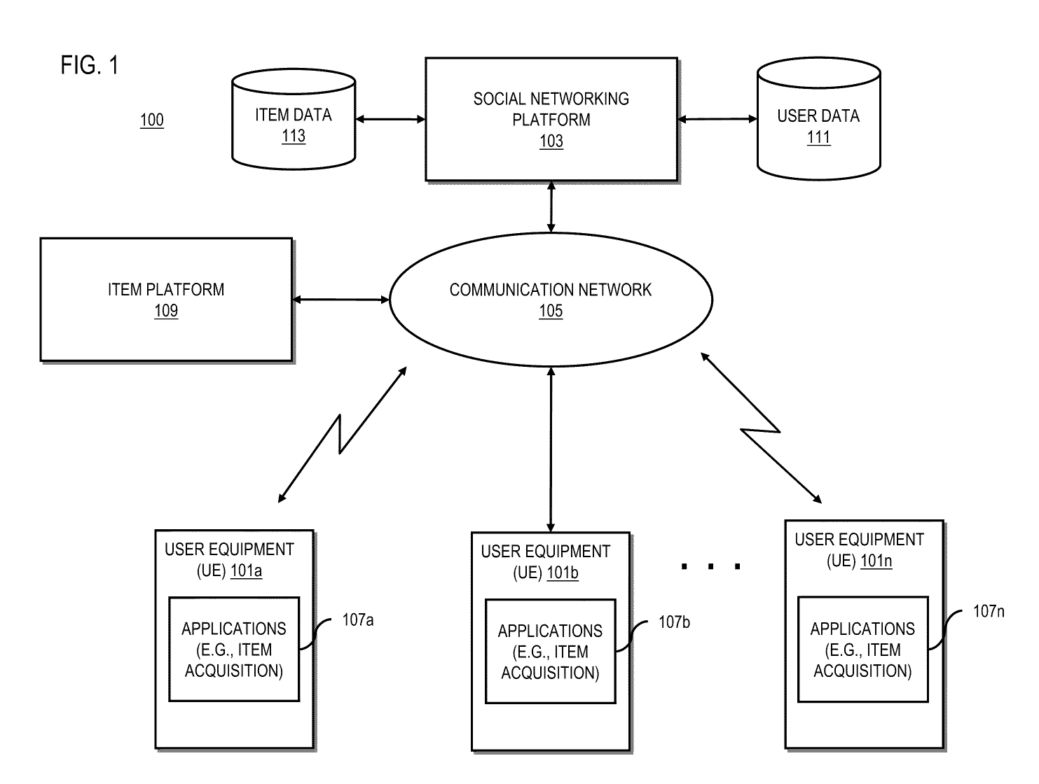

FIG. 1 is a diagram of a system capable of coordinating the acquisition of items, according to one embodiment. As noted above, many goods and/or services providers allow users to acquire (e.g., reserve, purchase, or otherwise obtain rights to) items starting at a particular time, such as an availability time and/or date. In certain embodiments, an item includes goods and/or services that can be acquired by one or more users. Further, an item can include limited availability items that have availability restricted by one or more factors. One such factor may be the total quantity of items of the sort (e.g., there may be a certain number of event tickets available for an event). Another factor may include the availability of the items at a particular time and/or location (e.g., a limited quantity of a new cellular phone or gaming system may be put on sale at a particular location at a certain time). In many instances, goods available at an initial offering may be sold out in a relatively short amount of time. A further factor may include the provider of the goods and/or service limiting the amount of items acquired at a particular time. In such a scenario, the user must wait in a queue to receive more items after the user acquires a set of the items, the quantity of which is limited by the provider. By way of example, the providers may present these limitations for a variety of reasons, including because there is a limited quantity of items, to generate interest in the items, or the like.

In certain scenarios, it is more likely that users have a greater chance to acquire items of limited availability by grouping together to achieve a goal to obtain a certain amount of items. However, there are many significant technical challenges to enabling the coordination of activities among users to obtain the items. For example, the users may be located at a great distance from each other and may not be able to quickly and efficiently communicate. Moreover, it may be difficult to find other users who are interested in obtaining the same items. Further, it can be difficult to coordinate activities between users as the number of users increases. For example, in a small group situation, a user may call another user to update the other user on the user's status, but in a larger group, many calls may be needed to communicate the user's status. Additionally, the calls may take an extended amount of time, leaving the user's status information stale.

To address this problem, a system 100 of FIG. 1 introduces the capability to coordinate the acquisition of items among multiple users. In one embodiment, user equipment (UEs) 101a-101n may be utilized to coordinate the acquisition of items via a social networking platform 103 over a communication network 105. In certain embodiments, the social networking platform 103 (e.g., a computing device) may be utilized to coordinate and facilitate communications between UEs 101 for the acquiring items (e.g., limited availability items). Examples of social networking platforms 103 include social networking websites and services (e.g., Facebook™, Twitter™, MySpace™ etc.), as well as other computing devices (e.g., a server to coordinate communications between UEs 101 such as a chatting service). Users may execute one or more applications 107a-107n (e.g., a social networking application, a messaging application, an item acquisition application, etc.) on the user's UEs 101a-101n to access the social networking platform 103 as well as other platforms that may be accessible via the communication network 105. Further, in certain embodiments, the UEs 101 may be utilized to communicate, via the communication network 105, with an item platform 109 to acquire items. In other embodiments, other devices may be utilized to acquire the items or the items may be acquired by a user of one of the UEs 101 in person (e.g., at a ticket office). Thus, an item platform 109 need not be connected to the communication network 105. Although various embodiments are described with respect to tickets and/or ticket items, it is contemplated that the approach described herein may be used with other goods and/or service items.

As noted above, in certain embodiments, the UE 101 includes an item acquisition application 107. Although various embodiments are described with respect to the item acquisition application 107, it is contemplated that the approaches described herein may be performed (or partially performed) by other applications (e.g., a social networking application). The item acquisition application 107 may be, in certain scenarios, a program that utilizes an application programming interface (API) to utilize one or more services of the social networking platform 103. The item acquisition application 107 may further be a widget that can be installed and executed in a web page or a web runtime engine or a native program.

In one embodiment, the item acquisition application 107 enables the user to initiate a search for other users that have interest in acquiring the same items (e.g., event tickets such as concert tickets, Olympic Games tickets, sporting event tickets, theater tickets, movie tickets, etc., goods such as electronics, toys, etc., or the like). The search for other users that have interest in acquiring the same items may be utilized to increase the number of users to attempt to obtain the items. The acquisition application 107 can send a message to the social networking platform 103 identifying the items that the user wishes to acquire. This information may be associated with user data 111 of the user. The user data 111 can store information about the user as a guest of the social networking platform 103 or as a member of the social networking platform 103. Then, information about the item can be posted to other users of the social networking platform 103 based on an association with the item. Further, the user may provide item data 113 that may be utilized to specify the item the user desires. The item data 113 and/or user data 111 can be published to one or more users (e.g., members or guests) of the social networking platform 103. Examples of publication can be via a post on a forum, e-mails to other users, selected distribution (e.g., selecting one or more other users to receive the acquisition information), or the like. Then, other users may notice the publication and join a group to acquire the item. In certain scenarios, the user may predetermine or designate the users who are interested in the acquisition of the items and enter contact information associated with the users. Group information may be stored with the user data 111 and may include contact information for each of the users interested in acquiring the item. Contact information may include a name, a physical address, an electronic mail address, a social networking identifier, a chat identifier, an instant messaging identifier, a phone number (e.g., a mobile phone number), a combination thereof, or other like information.

In certain embodiments, the item data 113 is linked to the group information and/or contact information. The item data 113 may include a description of the items including uses for the items, the cost of the items, locations where the items may be used, event information that may be associated with the acquisition of the items including information related to the timing of the event and/or the location of the event (e.g., a physical location, one or more phone numbers to call for acquiring the items, a website address, etc.), the number of items available, the number of items available per person, a combination thereof, or other like information. As noted above, the number of items available per person may be a limitation on the amount of items a single person may acquire during an iteration of the acquisition event. For example, if a person stands on line at a box office window to acquire concert tickets, the person may only be allowed to purchase 10 tickets at the window and may be required to return to the line to purchase additional tickets.

To facilitate obtaining the item or items, the social networking platform 103 may be utilized to coordinate the acquisition of items by the users in the group with a shared interest to obtain the item. Each user may input a quantity of the item the user is interested in acquiring. Further, the item data 113 may include the time of an acquisition event to obtain the items, the methods that can be utilized to acquire the items, and the total quantity of items desired. Examples of methods to acquire the items during an acquisition event may include a physical acquisition, online acquisition, over the phone acquisition, etc. The social networking platform 103 may provide the time of the acquisition event as an alert to the item acquisition application 107 of each of the UEs 101 of the users included in the group. In this manner, the UEs 101 can alert the user to activate the item acquisition application 107 and prepare for the item acquisition event. The alert may be set for a predetermined time before the acquisition event or at the time of the acquisition event.

Further, once the item acquisition application 107 on each UE 101 is activated for a particular acquisition event, the item acquisition application 107 may send a message to the social networking platform 103 notifying the social networking platform 103 that the user of the UE 101 is ready to acquire the items at the time of the acquisition event. The social networking platform 103 can receive the messages and compare the messages to the group of users associated with the item acquisition event. Then, the social networking platform 103 determines whether any of the users in the group are have not sent a message confirming that the user is ready to acquire the items. At this point, the social networking platform 103 may notify the members of the group of the delinquency of the users that have not confirmed that the users are ready. Additionally or alternatively, the social networking platform 103 may provide reminders (e.g., via a Short Message Service (SMS), Multimedia Messaging Service (MMS), a phone call, via an instant message, etc.) to the delinquent user based on one or more details associated with the user in the contact information. In the case that the members of the group are notified, the members may be presented with the opportunity to attempt to communicate with the delinquent user(s) via different communication methods.

Then, at the time of the acquisition event or at a time prior to the acquisition event, the social networking platform 103 coordinates the acquisition of the items for the users. To facilitate the acquisition, the social networking platform 103 may establish a communication session among the UEs 101 (e.g., chat sessions). In certain embodiments, one of the UEs 101 may be utilized to coordinate the acquisition in place of or in addition to the social networking platform 103. When users of the UEs 101 acquire one or more items, the user enters status information into the item acquisition application 107. In certain embodiments, status information is information regarding the acquisition status of a user. For example, status information may include the quantity of items acquired, a cost for the items, an online status of the UE 101, etc. Then, the UE 101 transmits this information to the social networking platform 103. Next, the social networking platform 103 compares the status information with the total amount of items to acquire from the item data 113. The social networking platform 103 then updates the total number of items left to acquire (e.g., by subtracting the total number of items from the number of items acquired). Then, the social networking platform 103 can update the users' UEs 101 with the new total number of items left to acquire. As other users acquire more items, the total number of items left to acquire is updated. In this manner, each user knows the total amount left to acquire so that the group does not obtain extra items. When the total number of items left to acquire reaches zero or another indicator that the objective amount of items to acquire has been achieved, the social networking platform 103 can send a message indicating that the users have completed their objective. Then, users may stop attempting to acquire additional items.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UE 101, item platform 109, and social networking platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

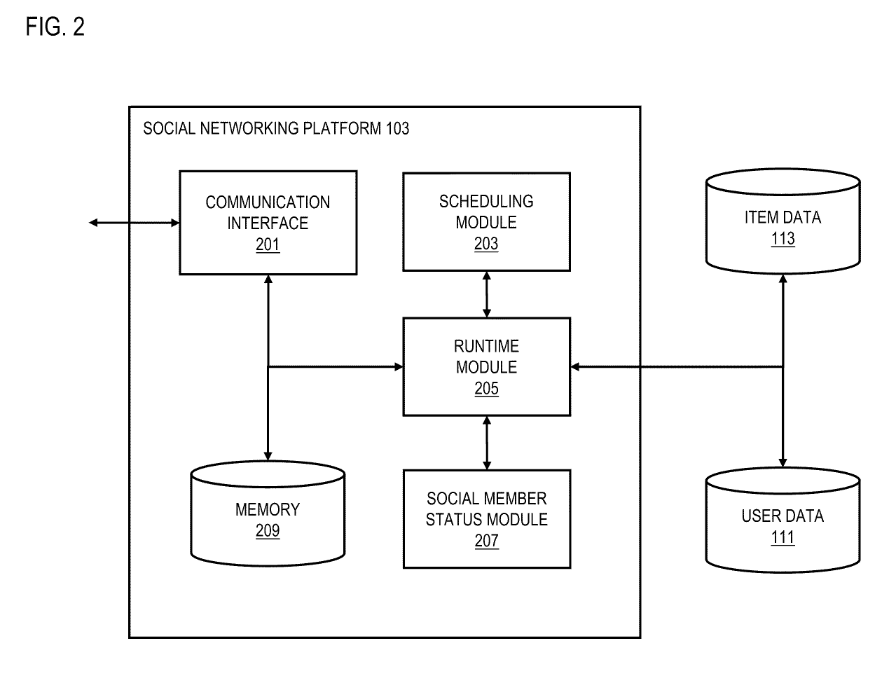

FIG. 2 is a diagram of the components of a social networking platform capable of coordinating the acquisition of items, according to one embodiment. By way of example, the social networking platform 103 includes one or more components for providing coordination of users to acquire one or more items. It is contemplated that the functions of these components may be combined in one or more components or performed by other components of equivalent functionality. In this embodiment, the social networking platform 103 includes a communication interface 201, a scheduling module 203, a runtime module 205 that can execute processes, a social member status module 207 that can be used to determine the status of one or more UEs 101 associated with users, and a memory 209.

In one embodiment, the social networking platform 103 includes a communication interface 201. The communication interface 201 can be used to communicate with a UE 101. The social networking platform 103 can receive information from the UE 101 via the communication interface 201 via methods such as internet protocol, MMS, SMS, GPRS, or any other available communication method. The UE 101 can send information to the social networking platform 103 for many reasons, such as to update the status of applications executing on the UE 101 as well as to update the acquisition status of items, updating user data 111 and/or item data 113, etc. Further, the runtime module 205 may utilize the communication interface 201 to provide status updates to the UE 101.

The scheduling module 203 may additionally be updated using the communication interface 201. The scheduling module 203 may be utilized to schedule acquisition events and/or alerts for acquisition events. Schedules and/or alerts may be stored in the memory 209, item data 113, and/or user data 111. The scheduling module 203 may change scheduling alerts based on user input. Further, the scheduling module 203 may use the communication interface 201 to communicate with other services (e.g., an item platform 109) that may provide the runtime module 205 with updates to the acquisition event. In this manner, the runtime module 205 may monitor changes to the acquisition event (e.g., if the provider of the item changes the date or time of the acquisition event and updates a website with the new information).

The social member status module 207 can track the status of UEs 101. The status may be utilized to determine if one or more users are not meeting the user's burden (e.g., is not online during the acquisition event) in attempting to acquire the items. Further, the social member status module 207 may be utilized by the runtime module 205 to provide alerts to the UEs 101 via the communication interface 201 to update the users of the status of the other members. In certain embodiments, item acquisition applications 107 on the UEs 101 may be configured to send a ready or online status message or confirmation to the social networking platform 103 when the user is ready. The item acquisition application 107 may require that a user manually provide input that the user is ready to attempt to acquire the item(s). In other embodiments, the social member status module 207 may request that UEs 101 send an online status message (e.g., via an internet connection, via SMS, via MMS, or via another communication method). Further, the social member status module 207 may additionally receive status updates from users indicating whether the user has been able to acquire one or more items. During the item acquisition event, the runtime module 205 may update the remaining quantity of items left to acquire based on updates from the users' UEs 101.

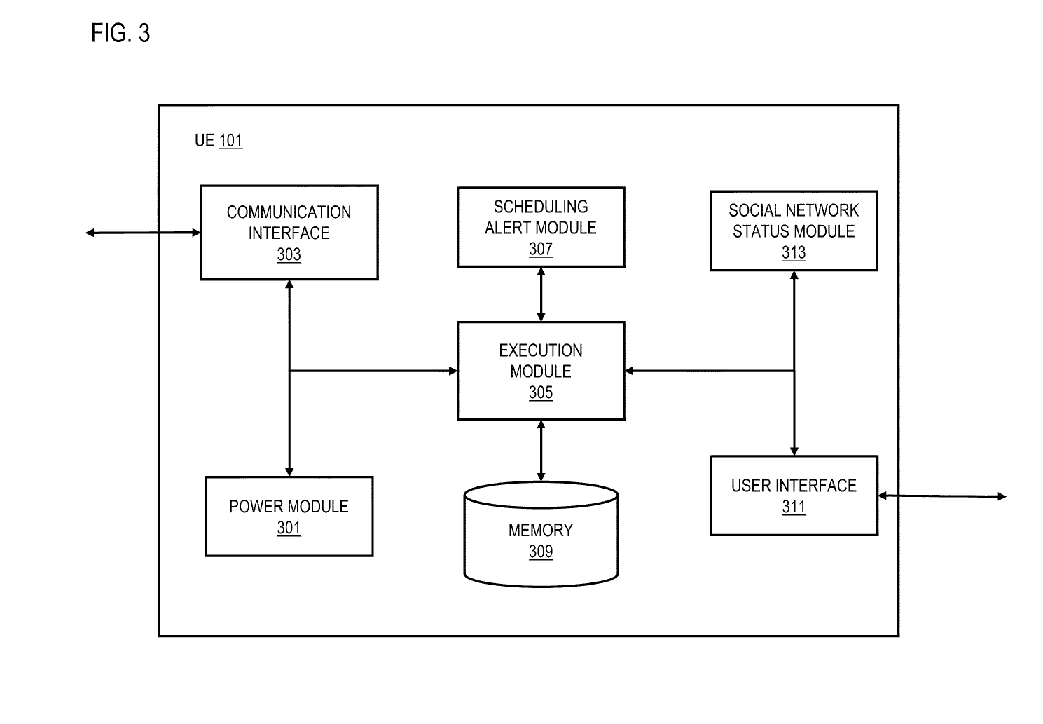

FIG. 3 is a diagram of the components of user equipment, according to one embodiment. It is contemplated that the functions of these components may be combined in one or more components or performed by other components of equivalent functionality. In this embodiment, the UE 101 includes a power module 301 to provide power and power controls to the UE 101, a communication interface 303 to communicate over a network, an execution module 305 to control the runtime of applications executing on the UE 101, a scheduling alert module 307 for alerting a user of the UE 101, a memory 309, a user interface 311 to output and receive input at the UE 101, and a social network status module 313 to update the status of the user.

In one embodiment, the UE 101 includes a power module 301. The power module 301 provides power to the UE 101. The power module 301 can include any type of power source (e.g., battery, plug-in, etc.). Additionally, the power module 301 can provide power to the components of the UE 101 including processors, memory 309, and transmitters.

The communication interface 303 may include multiple means of communication. For example, the communication interface 303 may be able to communicate over SMS, internet protocol, instant messaging, voice sessions (e.g., via a phone network), or other types of communication. The communication interface 303 can be used by the execution module 305 to communicate with other UEs 101, the social networking platform 103, an item platform 109, and other devices. In some examples, the communication interface 303 is used to transmit information (e.g., item acquisition information, user status information, etc.) to the social networking platform 103.

In one embodiment, a UE 101 includes a user interface 311. The user interface 311 can include various methods of communication. For example, the user interface 311 can have outputs including a visual component (e.g., a screen), an audio component, a physical component (e.g., vibrations), and other methods of communication. User inputs can include a touch-screen interface, a scroll-and-click interface, a button interface, etc. In certain embodiments, the user interface 311 may additionally have a vocal user interface component. As such, a text-to-speech mechanism may be utilized to provide textual information to the user. Further, a speech-to-text mechanism may be utilized to receive vocal input and convert the vocal input into textual input. Moreover, the user interface 311 may be utilized to present status information as to the status of an item acquisition effort during an item acquisition event.

In certain embodiments, an item acquisition application 107 may run on the execution module 305. The item acquisition application 107 may utilize the user interface 311 to receive information regarding an item and/or acquisition of the item. Further, this information may be transmitted via the communication interface 303 to the social networking platform 103. Moreover, the information may be utilized by a scheduling alert module 307 to alert the user about an upcoming item acquisition event. The scheduling alert module 307 may additionally or alternatively utilize information from a social networking platform 103 (e.g., a scheduled item acquisition event) for determining alerts. This information may be stored in the memory 309 until utilized. Additionally, the user interface 311 may be utilized to present alerts from the scheduling alert module 307. Thus, the user may receive an alert during a scheduled time. The scheduled time may be before an item acquisition event begins, when the item acquisition event begins, after the item acquisition event begins, a combination thereof, or the like. Further more than one alert may be presented to the user. When the alert is presented, the execution module 305 can be configured to send a status message to the social networking platform 103 notifying the social networking platform 103 that the user is ready and/or active to acquire items.

The item acquisition application 107 may set the social network status module 313 to indicate that the user is active. Further, the social network status module 313 may additionally be utilized to determine the number of items required for the group and/or the number of items acquired by the user. When the user acquires an item during the item acquisition event, the user inputs the acquisition information into the user interface 311 for the social network status module 313. The social network status module 313 may then utilize the communication interface 303 to update the social networking platform 103 and/or other UEs 101 about the acquisition information. In certain embodiments, the user interface 311 may be configured to allow easy access to input the information as well as to present information about the status of the item acquisition. Further, the social network status module 313 may be utilized to present the status of the group to the user. The social network status module 313 may be updated using input from the user interface 311 and/or information from other UEs 101 or social networking platform 103 via the communication interface 303. Thus, in certain embodiments, the social network status module 313 may be utilized to determine the status of the group using updates from the user interface 311, UEs 101, the social networking platform 103, or a combination thereof. In other embodiments, the social networking platform 103 may determine the status and the social network status module 313 may receive the determined status. The status may be presented via the user interface 311. In certain embodiments, the status includes a number of items left to be acquired, the number of items acquired, or the like. When the item acquisition event begins, the number of items left to be acquired can include the total number of items to be acquired by the group. As more items are acquired, the number of items is updated and presented to the user via the user interface 311. In this manner, the user is informed of the number of items needed to obtain the target so that the user need not acquire more items than the group desires.

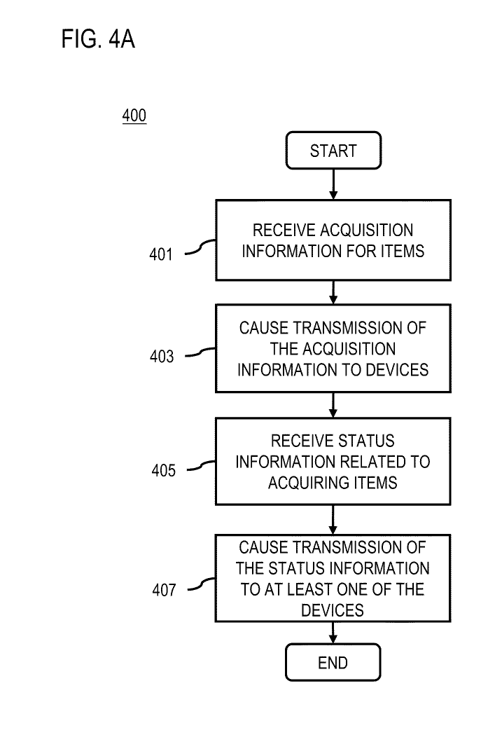

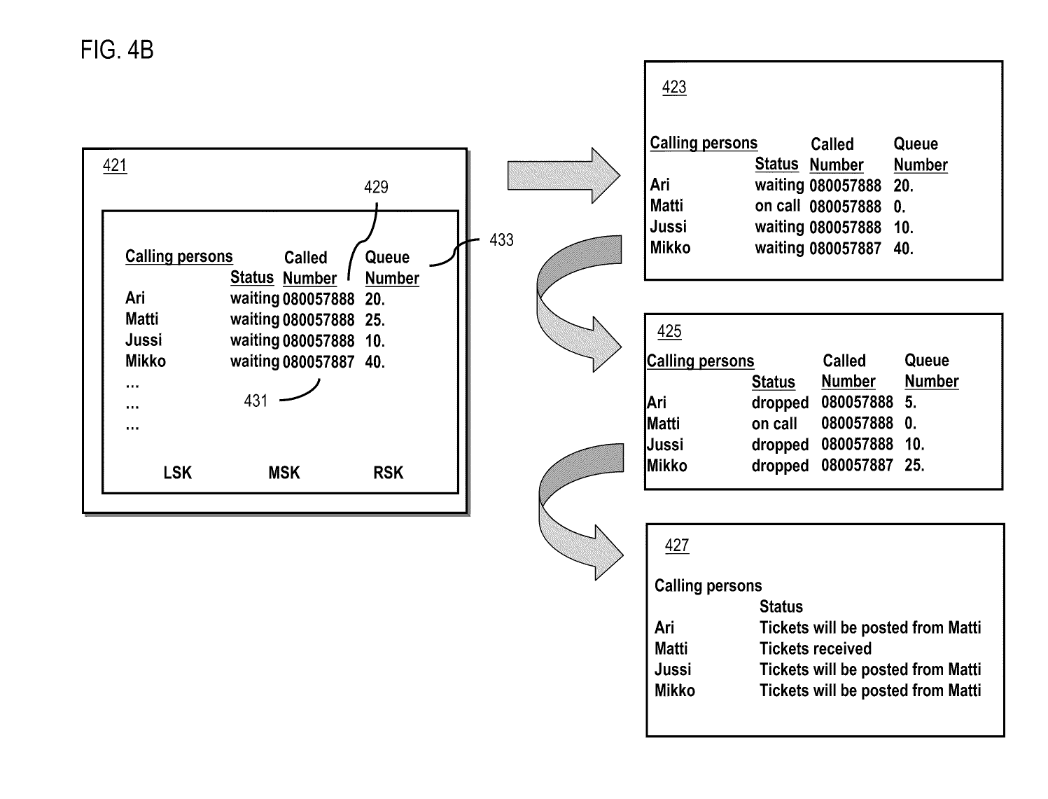

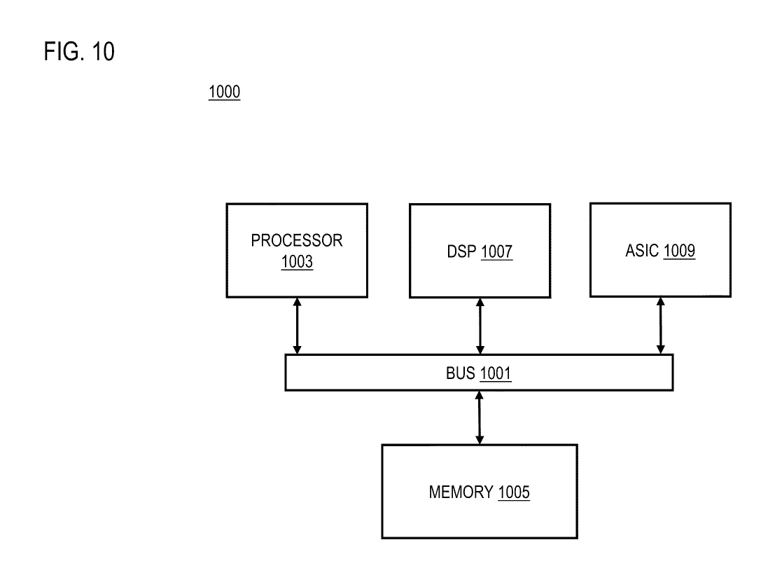

FIG. 4A is a flowchart of a process for coordinating the acquisition of items, according to one embodiment. In one embodiment, the runtime module 205 of the social networking platform 103 performs the process 400 and is implemented in, for instance, a chip set including a processor and a memory as shown FIG. 10. In certain embodiments, the execution module 305 of a UE 101 may perform one or more steps of the process performed by the runtime module 205. As such, the runtime module 205 or execution module 305 can provide means for accomplishing various parts of the process 400 as well as means for accomplishing other processes in conjunction with other components. In step 401, the runtime module 205 receives acquisition information for a plurality of items. The acquisition information may be received at the runtime module 205 via a communication interface 201. In certain embodiments, item acquisition information is data that can be utilized to coordinate the attainment of items. As such, item acquisition information may include information associated with group members with interest in obtaining the item(s) such as contact information of the group members, the number of items each group member desires, the time and location of the item acquisition event, etc. Further, the item acquisition information may include a total number of items the group members desire as well as information associated with an item acquisition event and/or items. Information associated with an item acquisition event and/or items may include a description of the items, the total number of items that can be acquired, the total number of items that can be acquired at a time (e.g., there may be a limit of 10 items per person), a description of one or more times or locations the acquisition event(s) can take place, etc. The description of the location(s) of the acquisition event(s) may include a website address, a phone number, one or more physical locations (e.g., a street address, location in a mall or landmark, etc.), or the like. Further, the item acquisition information may further include information associated with the time of the acquisition event and/or alerts for notifying one or more users about the item acquisition event.

At step 403, the runtime module 205 causes, at least in part, transmission of the acquisition information to a multiple (e.g., a plurality) of UEs 101. The runtime module 205 can thus provide means for accomplishing step 403. This transmission may be utilized to set up alerts for on the UEs 101 to ensure that users are ready for the item acquisition event. Further, the transmission may be utilized to cause an alert on one or more of the UEs 101. When the item acquisition event begins, an alert may additionally be caused to be transmitted by the runtime module 205. Moreover the UEs 101 may be configured to provide status information regarding the user of the UE 101. As such, when the UE 101 is ready (e.g., when the item acquisition application 107 is active) after a threshold time before an item acquisition event, the UE 101 may send and the runtime module 205 can receive a ready indicator message. Then, when the item acquisition event starts (or before it starts), the runtime module 205 can coordinate the acquisition of items. In certain embodiments, the runtime module 205 may cause, at least in part, the establishment of a communication session among the UEs 101. The communication session may be in the form of an established chat session. Additionally or alternatively, the runtime module 205 may provide communications to and from the UEs 101 via alternate methods.

Moreover, at step 405, the runtime module 205 receives from at least one of the UEs 101 status information related to acquiring at least a portion of the items. In certain embodiments, this status information may include a number of the items that the user of the UE 101 has acquired and/or a number of items that the user of the UE 101 is in the process of acquiring. An example of items (e.g., tickets) that may be considered in the process of being acquired can include when the user connects with an item provider (e.g., item platform 109). In other words, the user may be calling a phone number to obtain the tickets. The phone number may be busy or the user may be placed on hold. Then, when the user is able to order (e.g., connects to an operator), the user may provide information that the user has access and is in the process of acquiring a certain quantity of tickets. When the user completes the order, the user's UE 101 may initiate transmission of a message that the acquisition is complete. As such, the runtime module 205 may receive information about the status of individual users and UEs 101 in attempting to obtain items.

Then, at step 407, the runtime module 205 causes, at least in part transmission of the status information to at least another one of the UEs 101. In this manner, the status information may be shared with other UEs 101. Notifications and other status information transmitted to the UEs 101 from the social networking platform 103 may, in certain embodiments, include a protocol or request for a confirmation sent back from the UE 101 indicating that the transmission message to the UE 101 was successfully received. In other words, the message itself may include the request for a confirmation message and/or a protocol on the UE 101 may be utilized (e.g., the item acquisition application 107 may include the protocol). As such, the runtime module 205 is informed that the UEs 101 have received the status information. If a confirmation is not received, the runtime module 205 transmits the information again. The second transmission may be of a different method. For example, the first method may be via an internet transmission to the UEs 101. Further, the second method may include SMS, MMS, a phone call (e.g., an automated phone call message including the status information), a combination thereof, or another transmission.

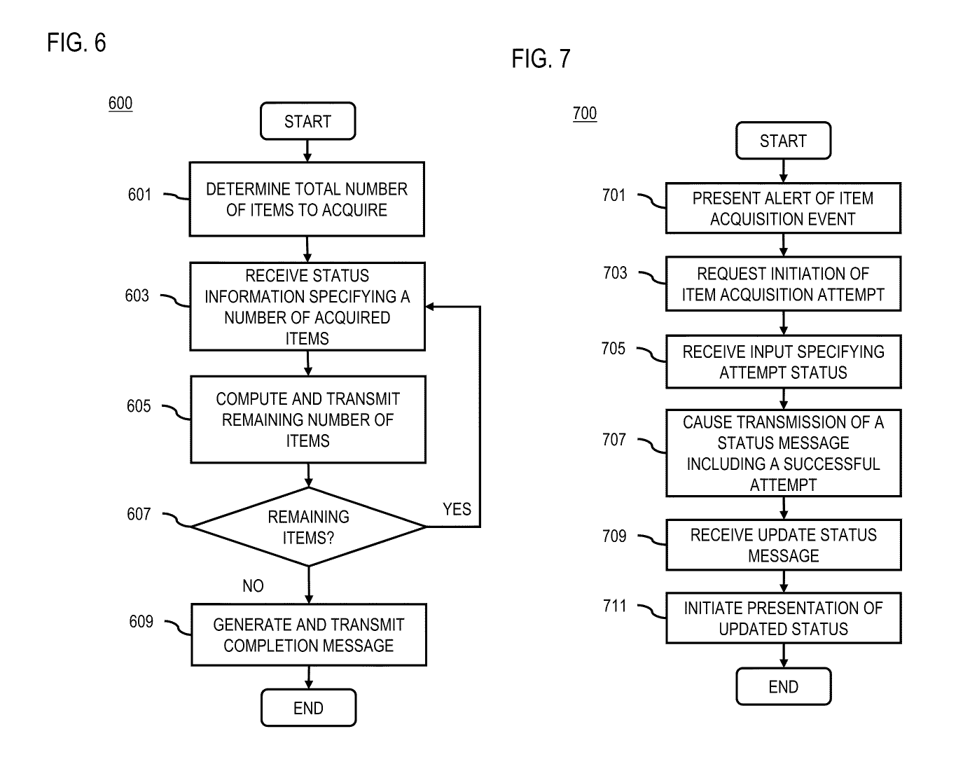

In certain scenarios, the status information may be augmented by the runtime module 205 to provide additional, augmented, or different information. The additional, augmented, or different information may include calculations that the runtime module 205 may perform on the status information. For example, the runtime module 205 may take the status information received from a UE 101 and information stored in a memory about the total quantity of items to acquire, number of items acquired, number of items left to acquire, number of items in the process of being acquired, a combination thereof, etc. and determine augmented status information (e.g., the number of items left to be acquired) as further detailed in the discussion of FIG. 6.

FIG. 4B is a diagram of a user interface utilized during the process of acquiring items, according to one embodiment. In this embodiment, four or more users attempt to acquire items utilizing the system 100. As such, the user interfaces 421, 423, 425, 427, are shown in different stages of utilizing the system 100 (e.g., according to the process 400 of FIG. 4A) to acquire items. In user interface 421, each of the users calls to acquire the items from an item provider. The service provider may have a primary phone number 429 as well as a secondary phone number 431. As such, the users may call the same or alternative numbers. The system 100 can track the numbers called by each user as well as the call status of the user (e.g., queue number 433). In certain embodiments, the queue number is a number provided by the provider to allow the user to know how far away the user is from speaking to an operator to acquire the items. Then, in user interface 423, one of the users, Matti, connects to the operator (e.g., queue number=0). When Matti connects, the other users are updated of the status of Matti. Then, in user interface 425, the other users drop off their attempt to acquire the items because Matti is acquiring the items for each of the users. Then, at user interface 427, Matti confirms that he was able to receive the items and the UE 101 is provided confirmation that the users have been allotted the desired items (e.g., tickets). Further, the status of the users can change based on what the user is doing. For example, the status may be “away” if the user and/or UE 101 of one of the users do not respond to queries; “waiting” if the UE 101 of one of the users has not yet established connection, but an attempt is pending; “on call” if one of the UEs 101 has connected to the item provider (e.g., talking to an operator); “dropped call” if the user of one of the UEs 101 has stopped attempting to acquire the item(s) (e.g., because another caller has successfully connected); etc.

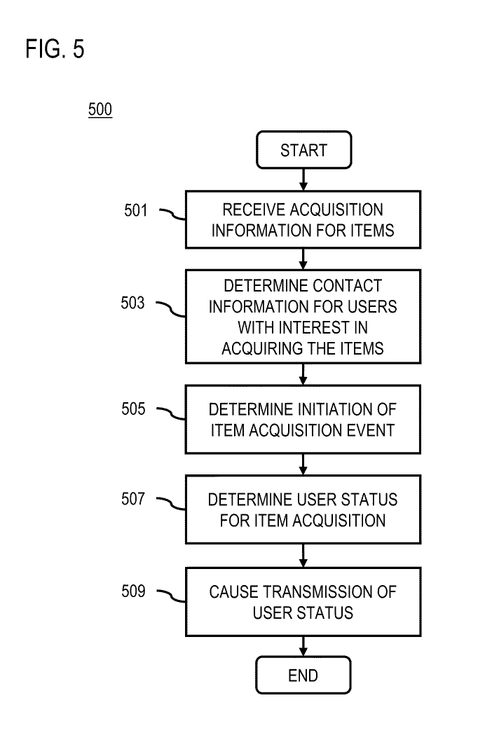

FIG. 5 is a flowchart of a process for alerting users of an item acquisition event, according to one embodiment. In one embodiment, the runtime module 205 of the social networking platform 103 performs the process 500 and is implemented in, for instance, a chip set including a processor and a memory as shown FIG. 10. In certain embodiments, the execution module 305 of a UE 101 may perform one or more steps of the process performed by the runtime module 205. As such, the runtime module 205 or execution module 305 can provide means for accomplishing various parts of the process 500 as well as means for accomplishing other processes in conjunction with other components. At step 501, the runtime module 205 receives acquisition information for items. The item acquisition information may be received via a communication interface 201 (e.g., from one or more UEs 101). As noted above, the acquisition information may include contact information of users interested in acquiring the items. This information is determined or extracted from the acquisition information (step 503). Additional users may further be added (e.g., via contact information supplied from the user's UE 101).

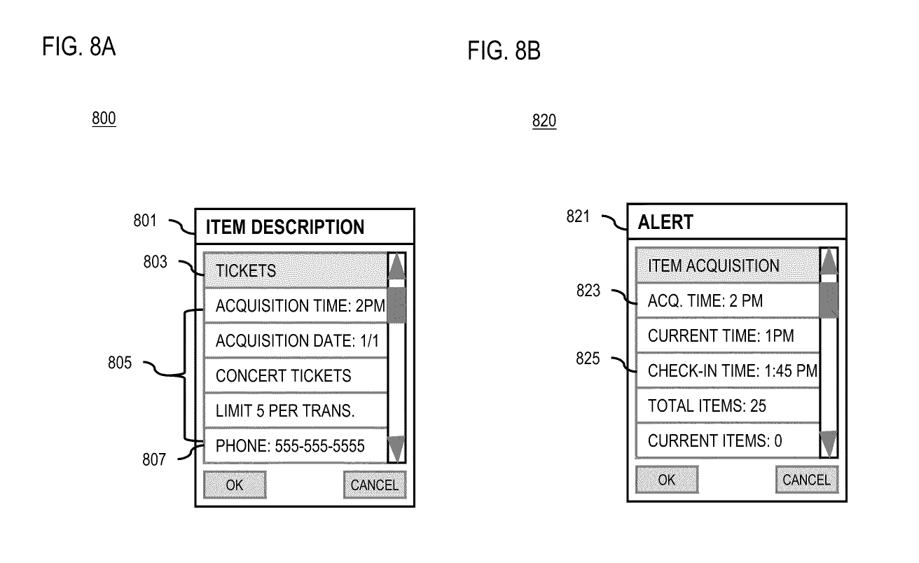

Moreover, the time of one or more item acquisition events may be determined or extracted from the acquisition information (step 505). This information may be utilized to set up alerts to notify users of the item acquisition event(s). Alerts may be presented on UEs 101 as further detailed in the process 700 of FIG. 7. Before an item acquisition event, the alerts may be utilized to gather users. An item acquisition application 107 executing on the UEs 101 may be utilized to provide the status of users. As such, the runtime module 205 may receive user status messages specifying the status of the user(s) and determine user status based on the messages (step 507). In one example, the runtime module 205 determines if the user's status is ready, not ready, or not available. The status of ready can indicate that the user is ready to attempt to acquire items. The status of not ready can indicate that the user is aware of the alert, but is not ready to attempt to acquire the items via the item acquisition event. This status may additionally be more specific and include a reason why the user is unable to participate in the item acquisition event, include information as to whether the user will be able to participate in the item acquisition event, if the user does not wish to participate in the item acquisition event anymore, if the user does not desire to acquire the items anymore, etc. Changes to item acquisition may be utilized to update a total number of items to acquire in other related coordination processes. Moreover, a not available status can be determined to indicate that there have been no communications with the UE 101 of a user since the time the alert was to activate.

When the runtime module 205 receives the user status from the users, the runtime module 205 can update the availability and status of the users. Then, at step 509, the runtime module 205 causes, at least in part, transmission of the status of one or more users to the users. The users may be contacted via their contact information. Further, users that have yet to be in contact since the alert time may be sent additional alerts via different or alternative communication methods (e.g., via e-mail, via a phone call, via a text message, etc.). Moreover, the runtime module 205 may assign one or more of the users to attempt to contact the user that has yet to contact the social networking platform 103. The user may be able to utilize methods of contacting the user that has not yet been in contact (e.g., the selected user may live nearby the user and can physically contact the user).

FIG. 6 is a flowchart of a process for coordinating the acquisition of items, according to one embodiment. In one embodiment, the runtime module 205 of the social networking platform 103 performs the process 600 and is implemented in, for instance, a chip set including a processor and a memory as shown FIG. 10. In certain embodiments, the execution module 305 of a UE 101 may perform one or more steps of the process performed by the runtime module 205. As such, the runtime module 205 or execution module 305 can provide means for accomplishing various parts of the process 600 as well as means for accomplishing other processes in conjunction with other components. At step 601, the runtime module 205 determines the total number of items to acquire. As noted above, the total number of items to acquire may be received from one or more UEs 101 or input via another method. Then, as previously mentioned, during an item acquisition event, the runtime module 205 receives status information specifying a number of acquired items from one of the UEs 101 (step 603). The runtime module 205 then computes a remaining number of items to acquire (or a total number of items acquired) (step 605). This may be based, at least in part, on the total number of items to acquire and the acquired number of items. The runtime module 205 may then cause, at least in part, transmission of the computed number of items to the UEs 101 associated with a group of users desiring to acquire the items.

Next, at step 607, the runtime module 205 determines if there are remaining items to acquire. If there are remaining items to acquire, the runtime module 205 waits for additional status information (step 603). If there are no remaining items to acquire (e.g., the computed number of remaining items is zero), the runtime module 205 generates a completion message to notify the UEs 101 that the item acquisition objective has been completed and the users need not attempt to acquire more items (step 609). Then, the runtime module 205 causes, at least in part, transmission of the completion message to the UEs 101. The UEs 101 may present this message to the users. As previously detailed, in certain embodiments, the runtime module 205 may be configured to detect (e.g., receive a confirmation message) from the UEs 101 indicating that the UEs 101 received the message(s). If the runtime module 205 does not receive the confirmation message, the runtime module 205 can be caused to retransmit the remaining number of items or the completion message in a different form of communication.

In certain embodiments, the item provider may run out of items before the remaining items requirement is fulfilled (e.g., a ticket provider runs out of tickets). The runtime module 205 can receive information from one or more of the users that the primary item provider has run out of items. As such, the runtime module 205 may search for secondary providers of the item (e.g., ticket resellers, ticket auctioneers, etc.). This information may additionally be provided to the users and the process can continue from step 603. Moreover the secondary providers as well as the primary provider may be utilized during all of the process 600 as well as for the processes 400, 500, 700. In certain embodiments, a portion of the users are directed to acquire the items based on the secondary sources and/or alternative primary sources. An example of an alternative primary source may be a physical ticket seller, while the primary source may be one or more telephone operators.

Further, the runtime module 205 may additionally provide for one or methods of assigning acquired items to users. For example, the user that actually acquired the items may have access to the items first. Additionally or alternatively, the items may be distributed based on a ranking or based on first come first serve (e.g., a person that helped establish the coordination effort may receive access to the items first).

FIG. 7 is a flowchart of a process for presenting item acquisition status information, according to one embodiment. In one embodiment, the execution module 305 of the UE 101 performs the process 700 and is implemented in, for instance, a chip set including a processor and a memory as shown FIG. 10. As such, the execution module 305 can provide means for accomplishing various parts of the process 700 as well as means for accomplishing other processes in conjunction with other components. At step 701, the execution module 305 presents an alert for an item acquisition event. As noted above, the execution module 305 may receive the alert from a social networking platform 103, via another UE 101, or via input from a user. Additionally or alternatively, the alert may be scheduled. An alert may trigger user interface 311 activity to notify a user of the UE 101 of the alert. The user interface may utilize sounds (e.g., beeping, alarms, etc.), visual cues (e.g., a scheduling popup, a reminder notification, etc.), vibrations, or other communication means to communicate to a user the start of an item acquisition event that the user has interest in attending.

The user may enter input notifying the execution module 305 that the user is ready. This may include simply using the UE 101. Then the execution module 305 causes presentation of a request to initiate an item acquisition attempt by the user (step 703). As noted above, an item acquisition attempt may include physically attempting to acquire items (e.g., at a box office), calling to acquire the items, acquiring the items online, or the like. The user is additionally provided with a prompt to specify information about the status of the user's attempt. The execution module 305 then, at step 705, receives input specifying the user's attempt status (e.g., via a user input). The user's attempt status may include intermediate status information or completed transaction status information. In this manner, the user is able provide the status information to other users using UEs 101 (e.g., via the social networking platform 103 or direct communications). As noted above, the intermediate status information may include information that the user has gained access to the item provider (e.g., the user is past holding or busy stage of communication with the item provider via a phone call, is talking to a teller at a physical location, etc.). The intermediate status information may additionally include information associated with the number of corresponding items the user thinks the user can get. Further, the completed transaction status information may be status information that the user has acquired a certain number of items. Then the status information is caused, at least in part to be transmitted to the other UEs 101 and/or the social networking platform 103 (step 707). As noted above, multiple users may provide update information.

As such, the execution module 305 receives a status update message from one of the other UEs 101 and/or the social networking platform 103 (step 709). Then, the status update message is formatted for presentation. Next, at step 711, the execution module 305 causes, at least in part, presentation of the updated status. As previously notes, the updated status may include a number of items to be acquired, a number of items acquired, a number of items left to be acquired, a combination thereof, etc.

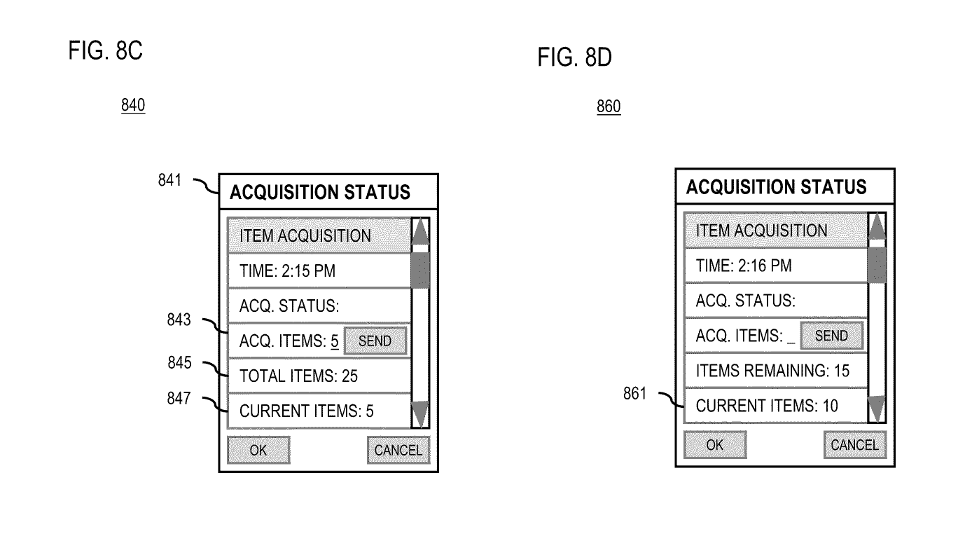

FIGS. 8A-8D are diagrams of user interfaces utilized in the processes of FIGS. 4-7, according to various embodiments. User interface 800 includes an exemplary interface utilized to display an item description 801. The item description 801 can include what the item(s) is utilized for, such as the item being a ticket 803 to an event (e.g., a concert) as well as information 805 about how to acquire the items. The information 805 may include times and dates for one or more acquisition events (e.g., an event to distribute or acquire the items). Further, the information includes information associated with methods to acquire the items (e.g., a phone number to call 807, locations to attempt to acquire the items, etc.). Users interested in acquiring the item(s) may be provide contact information via the user interface and receive an alert at the time of the item acquisition event.

User interface 820 displays an alert 821 according to one embodiment. In this alert, the user is presented with an acquisition event time 823 as well as a check-in time 825. The check-in time 825 may be utilized as a time when each of the users that are part of a coordinated item acquisition effort to check-in. If one or more of the users do not check-in before the check-in time, the other users may be notified of the users' status. With this information, the users may contact the user and/or remove the delinquent user from the coordinated item acquisition effort. A user may check in by, for instance, having an item acquisition application 107 on the user's UE 101 provide a message to one or more other UEs 101 or platforms 103 coordinating the effort.

When the item acquisition event begins, users can attempt to acquire the items while utilizing the item acquisition application 107 for updating the coordination effort. User interface 840 shows the acquisition status 841 of the group in obtaining the items. When the user acquires items, the user enters a number of items in an item acquisition field 843. Then, the user indicates to the item acquisition application 107 that the user wishes to send the update. The UE 101 then sends the item acquisition information to the social networking platform 103. Further, the user interface 840 additionally may provide the total number of items 845 the coordinated group effort wishes to acquire as well as the current number of items 847 acquired by group members. User interface 860 displays the acquisition status presented on one of the UEs 101 of the group after the user of user interface 840 enters information that the user acquired 5 items. In certain embodiments, as noted above, different methods may be utilized to provide item information to the user. As such, in alternative or in addition to a total items 845 field, the total items remaining to be acquired 861 may be presented to the user. The total items remaining may be calculated by subtracting the current items 861 from the desired number of total items 845.

With the above approaches, a coordinated system to acquire items is provided. In this manner, coordination between users to acquire items can be automated and provided in real time. The coordination system allows for the real time access of item acquisition information between users interested in acquiring items during an item acquisition event because the system is automated. The real time access allows for the users to know when to stop acquiring items to meet a desired quota of items. With these approaches, the user is knows when the user may stop attempting to acquire items. Further, the system provides for redundancy because if a user does not receive updates, the user may acquire extra, unwanted items.

The processes described herein for providing item acquisition coordination may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

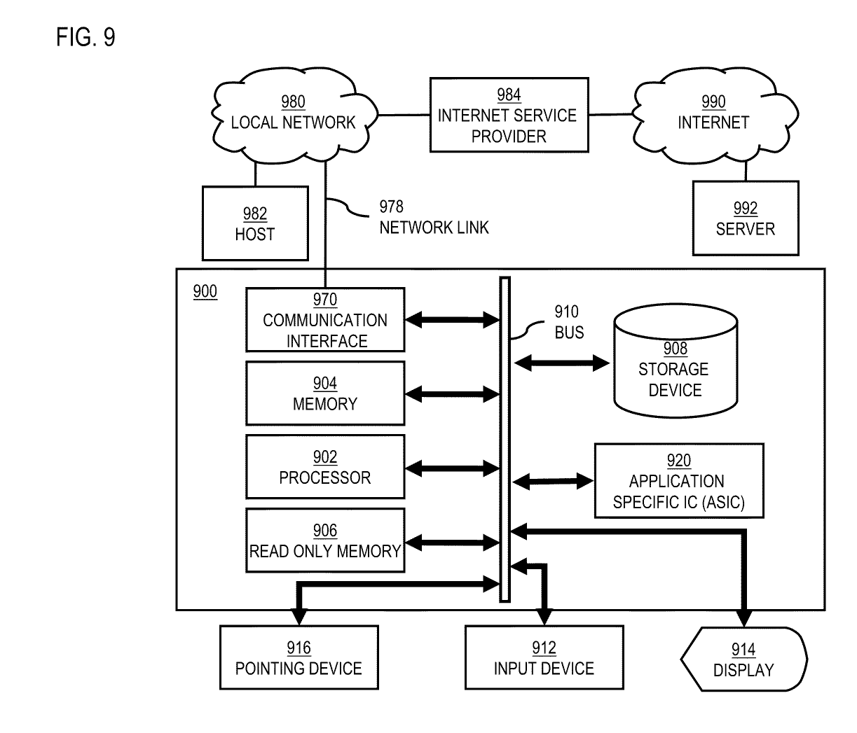

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide item acquisition coordination as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of coordinating item acquisition.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to item acquisition coordination. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for coordinating item acquisition. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for item acquisition coordination, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for the UE 101, social networking platform 103, and item platform 109.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to coordinate item acquisition as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of coordinating item acquisition.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to coordinate item acquisition. The memory 1005 also stores the data associated with or generated by the execution of the inventive steps.

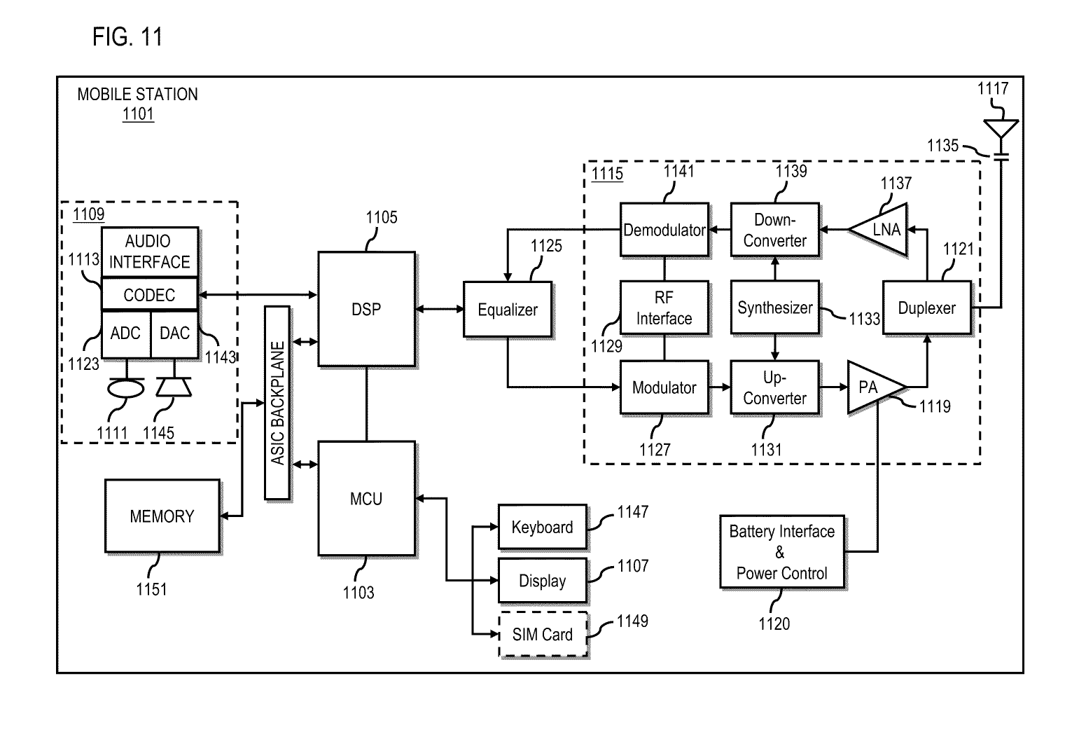

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of coordinating item acquisition. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of coordinating item acquisition. The display 11 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to coordinate item acquisition. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving acquisition information for a plurality of items;
causing, at least in part, transmission of the acquisition information to a plurality of devices;
receiving from at least one of the devices status information related to acquiring at least a portion of the items; and
causing, at least in part, transmission of the status information to at least another one of the devices.

2. A method of claim 1, further comprising:
causing, at least in part, establishment of a communication session among the devices.

3. A method of claim 1, wherein the status information includes at least in part information on an acquired number of the items, the method further comprising:
determining a total number of items to acquire from the acquisition information;
computing a remaining number of items to acquire based at least in part on the total number items and the acquired number of items; and
causing, at least in part, transmission of the remaining number of items to the devices.

4. A method of claim 3, wherein there is no remaining number of items, the method further comprising:
generating a completion message; and
causing, at least in part, transmission of the of the completion message to the devices.

5. A method of claim 4, further comprising:
detecting whether the transmission of the remaining number of items or the completion message was successful; and
causing, at least in part, retransmission of the remaining number of items or the completion message in a different form of communication based on the detection.

6. A method of claim 1, further comprising:
causing, at least in part, transmission of a reminder message to at least one of the devices based on the status information.

7. A method of claim 1, wherein the devices are associated in a social network, by an interest in the items, or a combination thereof.

8. A method of claim 1, wherein the items include event tickets, limited availability items, or a combination thereof.

9. An apparatus comprising:
at least one processor; and
at least one memory including computer program code, the at least one memory and the computer program code configured to, with the at least one processor, cause the apparatus to perform at least the following,
receive acquisition information for a plurality of items;
cause, at least in part, transmission of the acquisition information to a plurality of devices;
receive from at least one of the devices status information related to acquiring at least
a portion of the items; and
cause, at least in part, transmission of the status information to at least another one of the devices.

10. An apparatus of claim 9, wherein the apparatus is further caused, at least in part, to:
cause, at least in part, establishment of a communication session among the devices.

11. An apparatus of claim 9, wherein the status information includes at least in part information on an acquired number of the items, and wherein the apparatus is further caused, at least in part, to:
determine a total number of items to acquire from the acquisition information;
compute a remaining number of items to acquire based at least in part on the total number items and the acquired number of items; and
cause, at least in part, transmission of the remaining number of items to the devices.

12. An apparatus of claim 11, wherein there is no remaining number of items, and wherein the apparatus is further caused, at least in part, to:
generate a completion message; and
cause, at least in part, transmission of the of the completion message to the devices.

13. An apparatus of claim 12, wherein the apparatus is further caused, at least in part, to:
detect whether the transmission of the remaining number of items or the completion message was successful; and
cause, at least in part, retransmission of the remaining number of items or the completion message in a different form of communication based on the detection.

14. An apparatus of claim 9, wherein the apparatus is further caused, at least in part, to:
cause, at least in part, transmission of a reminder message to at least one of the devices based on the status information.

15. An apparatus of claim 9, wherein the devices are associated in a social network, by an interest in the items, or a combination thereof.

16. An apparatus of claim 9, wherein the items include event tickets, limited availability items, or a combination thereof.

17. A computer-readable storage medium carrying one or more sequences of one or more instructions which, when executed by one or more processors, cause an apparatus to at least perform the following steps:
receiving acquisition information for a plurality of items;
causing, at least in part, transmission of the acquisition information to a plurality of devices;
receiving from at least one of the devices status information related to acquiring at least a portion of the items; and
causing, at least in part, transmission of the status information to at least another one of the devices.

18. A computer-readable storage medium of claim 17, wherein the apparatus is caused, at least in part, to further perform:
causing, at least in part, establishment of a communication session among the devices.

19. A computer-readable storage medium of claim 17, wherein the status information includes at least in part information on an acquired number of the items, and wherein the apparatus is caused, at least in part, to further perform:
determining a total number of items to acquire from the acquisition information;
computing a remaining number of items to acquire based at least in part on the total number items and the acquired number of items; and
causing, at least in part, transmission of the remaining number of items to the devices.

20. A computer-readable storage medium of claim 19, wherein there is no remaining number of items, and wherein the apparatus is caused, at least in part, to further perform:
generating a completion message;
causing, at least in part, transmission of the of the completion message to the devices;
detecting whether the transmission of the remaining number of items or the completion message was successful; and
causing, at least in part, retransmission of the remaining number of items or the completion message in a different form of communication based on the detection.
